(19) United States
(12) Patent Application Publication
(10) Pub. No.: US 2013/0082898 A1
(43) Pub. Date: Apr. 4, 2013

(54) ANTENNA APPARATUS PROVIDED WITH TWO ANTENNA ELEMENTS AND SLEEVE ELEMENT FOR USE IN MOBILE COMMUNICATIONS

(71) Applicants: Kenichi Asanuma, Kyoto (JP); Atsushi Yamamoto, Kyoto (JP); Tsutomu Sakata, Osaka (JP)

(72) Inventors: Kenichi Asanuma, Kyoto (JP); Atsushi Yamamoto, Kyoto (JP); Tsutomu Sakata, Osaka (JP)

(21) Appl. No.: 13/703,456

(22) PCT Filed: Jan. 19, 2012
(86) PCT No.: PCT/JP2012/000321

§ 371 Date: Dec. 11, 2012

(30) Foreign Application Priority Data
Apr. 11, 2011 (JP) 2011-087057

(51) Int. Cl. H01Q 1/52

(52) U.S. Cl. CPC H01Q 1/521
USPC 343/893

(57) ABSTRACT

This antenna apparatus is provided with two antenna elements, two feeding lines, a feeding point provided at one end of the antenna element, and a feeding point provided at the one end of the antenna element. The feeding lines extend in a first direction from the feeding points. The antenna element extends from the feeding point in a second direction perpendicular to the first direction, and the antenna element extends from the feeding point in a third direction which is oriented opposite to the second direction. The antenna apparatus is provided with a sleeve element which has an end which is connected to a respective grounded conductor of each of the feeding lines at positions near the feeding points, and extends in the first direction from the position near the feeding points.

### TECHNICAL FIELD

The present invention mainly relates to an antenna apparatus for mobile communication apparatuses such as mobile phones, and a wireless communication apparatus including the antenna apparatus.

### BACKGROUND ART

The miniaturization and slimming down of portable wireless communication apparatuses such as mobile phones have been rapidly advanced. In addition, portable wireless communication apparatuses have been transformed from apparatuses to be only used as conventional telephones to data terminals that perform transmission and reception of emails, browsing of web pages by WWW (World Wide Web), etc. Further, information to be handled has also increased in size from conventional audio and text information to pictures and moving images. Thus, further improvement in communication quality is sought.

In such circumstances, there are proposed array antenna apparatuses capable of performing high-speed wireless communication by reducing electromagnetic coupling in a predetermined frequency band.

Patent Document 1 discloses an array antenna apparatus using a choke, and the electromagnetic coupling between antenna elements can be reduced by the effect of the choke.

Meanwhile, as a known technique, there is a method for configuring an array antenna in which a dipole antenna (Patent Document 2) or a sleeve antenna (Non-Patent Document 1) is configured in an end-fire arrangement or a broadside arrangement.

### PRIOR ART DOCUMENTS

### Patent Documents

[Patent Document 1] Japanese patent laid-open publication No. JP 05-145324 A
[Patent Document 2] Japanese patent laid-open publication No. JP 2006-217302 A

### Non-Patent Documents

[Non-Patent Document 1] Oshima, et al., “Transmission Characteristics of MIMO with Consideration of Space Correlation and Mutual Coupling of Array Antenna [I]: Mutual Coupling Characteristics of Array Antenna based on Radiation Pattern Measurement”, IEICE Technical Report, AP2007-103, pp. 7-12, November 2007.
[Non-Patent Document 2] Blanch, S.; Romeu, J.; Corbella, I., “Exact representation of antenna system diversity performance from input parameter description”, Electronics Letters, Volume 39, Issue 9, pp. 705-707, May 2003.

### SUMMARY OF THE INVENTION

### Problems to be Solved by the Invention

In recent years, due to an increasing need to increase the speed of data transmission on mobile phones, 3G-LTE (3rd Generation Partnership Project Long Term Evolution) which is a next generation mobile phone standard has been considered. In 3G-LTE, as a new technology for achieving an increase in the speed of wireless transmission, the adoption of a MIMO (Multiple Input Multiple Output) system is determined that simultaneously transmits and receives, by spatial division multiplexing, radio signals of a plurality of channels using a plurality of antenna elements. In the MIMO system, each of the transmitter side and the receiver side uses a plurality of antenna elements and data streams are spatially multiplexed, and this leads to achievement of an increase in transmission speed.

However, in the MIMO system, since the plurality of antenna elements are allowed to simultaneously operate at the same frequency, under circumstances where the plurality of antenna elements are mounted close to each other in a compact mobile phone, the electromagnetic coupling between the antenna elements becomes very strong. When the electromagnetic coupling between the antenna elements becomes strong, the radiation efficiency of the antenna elements degrades. Correspondingly, received radio waves are weakened, and this leads to a reduction in transmission speed. Hence, an array antenna having low coupling in a state in which the plurality of antenna elements is disposed close to each other is required.

In addition, in order for an antenna apparatus that performs communication of the MIMO system to implement spatial division multiplexing, the antenna apparatus needs to perform simultaneous transmission and reception of a plurality of radio signals having a low correlation therebetween, by using different directivities, polarization characteristics, or the like.

Further, for the purpose of mounting an antenna apparatus on a compact wireless terminal apparatus, there is a demand for miniaturization of the antenna elements.

The antenna apparatus of Patent Document 1 can reduce the electromagnetic coupling using the choke, but has such a problem that since a plurality of antenna elements is arranged, the mounting area for the antenna apparatus increases.

In addition, although there is a method in which the dipole antenna (Patent Document 2) or the sleeve antenna (Non-Patent Document 1) is configured in array, when the distance between antenna elements is reduced, the electromagnetic coupling between the antenna elements becomes strong. Thus, there is such a problem that to ensure high radiation efficiency, a sufficient distance needs to be maintained between the antenna elements.

Thus, in the case of a limited mounting area, e.g., compact wireless terminal apparatuses such as mobile phones, the antenna apparatuses of the prior art are not suitable.

An object of the present invention is to solve the above-described problems, and provide an antenna apparatus capable of performing simultaneous transmission and reception of a plurality of radio signals having a low correlation therebetween, with a simpler configuration compared to those of the prior art, and provide a wireless communication apparatus including such an antenna apparatus.

According to a first aspect of the present invention, there is provided an antenna apparatus including first and second antenna elements, first and second feeding lines each having a signal line and a ground conductor, first and second feeding lines each having a signal line and a ground conductor, and first and second feeding points. The first feeding point is provided at one end of the first antenna element and connected to the signal line of the first feeding line, and the second feeding point is provided at one end of the second antenna element and connected to the signal line of the second feeding line. The first and second feeding lines extend in a first direction from the first and second feeding points, respectively, the first antenna element extends from the first feeding point in a second direction substantially perpendicular to the first direction, and the second antenna element extends from the second feeding point in a third direction being a substantially opposite direction to the second direction. The antenna apparatus further includes at least one sleeve element that has one end connected to the ground conductors of the first and second feeding lines at a location close to the first and second feeding points, and extends in the first direction from the location close to the first and second feeding points.

In the above-mentioned antenna apparatus, at least one of the sleeve elements is a single cylindrical conductor that surrounds the first and second feeding lines.

In the above-mentioned antenna apparatus, at least one of the sleeve elements includes a first sleeve element being a single cylindrical conductor that surrounds the first feeding line; and a second sleeve element being a single cylindrical conductor that surrounds the second feeding line.

In the above-mentioned antenna apparatus, the first and second sleeve elements are in contact with each other.

In the above-mentioned antenna apparatus, the first and second sleeve elements are separated from each other.

In the above-mentioned antenna apparatus, at least one of the sleeve elements is at least one linear conductor.

In the above-mentioned antenna apparatus, the ground conductors of the first and second feeding lines are in contact with each other.

In the above-mentioned antenna apparatus, the first and second feeding lines are separated from each other, and at least one of the sleeve elements includes at least one sleeve element connected to the first feeding line; and at least one sleeve element connected to the second feeding line.

In the above-mentioned antenna apparatus, the first and second feeding lines are microstrip lines formed on a dielectric substrate, and the first and second antenna elements and at least one of the sleeve elements are formed in patterns on the dielectric substrate.

In the above-mentioned antenna apparatus, the first and second feeding lines are coplanar lines formed on a dielectric substrate, and the first and second antenna elements and at least one of the sleeve elements are formed in patterns on the dielectric substrate.

In the above-mentioned antenna apparatus, the first and second antenna elements and at least one of the sleeve elements have a first electrical length, and the first antenna element includes a first trap circuit at a location of a second electrical length different than the first electrical length, from the first feeding point. The second antenna element includes a second trap circuit at a location of the second electrical length from the second feeding point. At least one of the sleeve elements includes a third trap circuit at a location of the second electrical length from the one end thereof connected to the ground conductors of the first and second feeding lines. Each of the first, second, and third trap circuits is made to be substantially a short-circuit at a first frequency, and is substantially open at a second frequency higher than the first frequency.

In the above-mentioned antenna apparatus, the first and second antenna elements have a first electrical length, and the antenna apparatus further comprises third and fourth antenna elements each having a second electrical length different than the first electrical length. The third antenna element extends from the first feeding point in a fourth direction substantially perpendicular to the first direction, and the fourth antenna element extends from the second feeding point in a fifth direction being a substantially opposite direction to the fourth direction. At least one of the sleeve elements includes a first sleeve element having the first electrical length; and a second sleeve element having the second electrical length.

According to a second aspect of the present invention, there is provided a wireless communication apparatus including the antenna apparatus according to the first aspect of the present invention.

### Effect of the Invention

The antenna apparatus and wireless communication apparatus of the present invention can perform simultaneous transmission and reception of a plurality of radio signals having a low correlation therebetween by means of the antenna elements by reducing the electromagnetic coupling between the antenna elements, with a simpler configuration compared to those of the prior art.

### BRIEF DESCRIPTION OF THE DRAWINGS

FIG. 1 is a perspective view showing a schematic configuration of an antenna apparatus according to a first embodiment of the present invention.

FIG. 2 is a cross-sectional view showing a portion near feeding points P1 and P2 of the antenna apparatus of FIG. 1 and is a cross-sectional view along a plane parallel to an XZ-plane passing through the feeding points P1 and P2 and feeding lines L1 and L2.

FIG. 3 is a cross-sectional view of the antenna apparatus of FIG. 1 and is a cross-sectional view along a plane parallel to an XY-plane passing through a sleeve element S0.

FIG. 4 is a perspective view showing a schematic configuration of an antenna apparatus according to a first modified embodiment of the first embodiment of the present invention.

FIG. 5 is a cross-sectional view showing a portion near feeding points P1 and P2 of the antenna apparatus of FIG. 4 and is a cross-sectional view along a plane parallel to an XZ-plane passing through the feeding points P1 and P2 and feeding lines L1 and L2.

FIG. 6 is a cross-sectional view of the antenna apparatus of FIG. 4 and is a cross-sectional view along a plane parallel to an XY-plane passing through sleeve elements S1 and S2.

FIG. 7 is a perspective view showing a schematic configuration of an antenna apparatus according to a second modified embodiment of the first embodiment of the present invention.

FIG. 8 is a graph showing an electromagnetic coupling between antenna elements A 1 and A2 of the antenna apparatus of FIG. 7.

FIG. 9 is a diagram showing a current distribution of a comparative example of the antenna apparatus of FIG. 1.

FIG. 10 is a diagram showing a current distribution of the antenna apparatus of FIG. 1.

FIG. 11 is a perspective view showing a case in which the open angle between antenna elements A 1 and A2 of the antenna apparatus of FIG. 1 changes on the XZ-plane.

FIG. 12 is a graph showing an electromagnetic coupling between the antenna elements A1 and A2 of the antenna apparatus of FIG. 11.

FIG. 13 is a perspective view showing a case in which the open angle between the antenna elements A1 and A2 of the antenna apparatus of FIG. 1 changes on the XY-plane.

FIG. 14 is a graph showing an electromagnetic coupling between the antenna elements A 1 and A2 of the antenna apparatus of FIG. 13.

FIG. 15 is a perspective view showing a schematic configuration of an antenna apparatus according to a second embodiment of the present invention.

FIG. 16 is a perspective view showing a schematic configuration of an antenna apparatus according to a modified embodiment of the second embodiment of the present invention.

FIG. 17 is a perspective view showing a schematic configuration of an antenna apparatus according to a third embodiment of the present invention.

FIG. 18 is a perspective view showing a schematic configuration of an antenna apparatus according to a first modified embodiment of the third embodiment of the present invention.

FIG. 19 is a perspective view showing a schematic configuration of an antenna apparatus according to a second modified embodiment of the third embodiment of the present invention.

FIG. 20 is a perspective view showing a schematic configuration of an antenna apparatus according to a fourth embodiment of the present invention.

FIG. 21 is a circuit diagram showing trap circuits T0, T1, and T2 of FIG. 20.

FIG. 22 is a perspective view showing a schematic configuration of an antenna apparatus according to a first modified embodiment of the fourth embodiment of the present invention.

FIG. 23 is a perspective view showing a schematic configuration of an antenna apparatus according to a second modified embodiment of the fourth embodiment of the present invention.

FIG. 24 is a graph showing S-parameters of an antenna apparatus according to an implementation example of the present invention.

FIG. 25 is a perspective view showing a schematic configuration of an antenna apparatus according to a comparative example.

FIG. 26 is a graph showing an electromagnetic coupling between antenna elements A1 and A2 of the antenna apparatus of FIG. 25.

FIG. 27 is a graph showing S-parameters of the antenna apparatus of FIG. 25.

FIG. 28 is a graph showing radiation efficiencies of the antenna apparatuses according to the implementation example of the present invention and the comparative example.

FIG. 29 is a graph showing correlation coefficients of the antenna apparatuses according to the implementation example of the present invention and the comparative example.

### MODE FOR CARRYING OUT THE INVENTION

Embodiments of the present invention will be described below with reference to the drawings. It is noted that like components are denoted by the same reference characters.

### First Embodiment

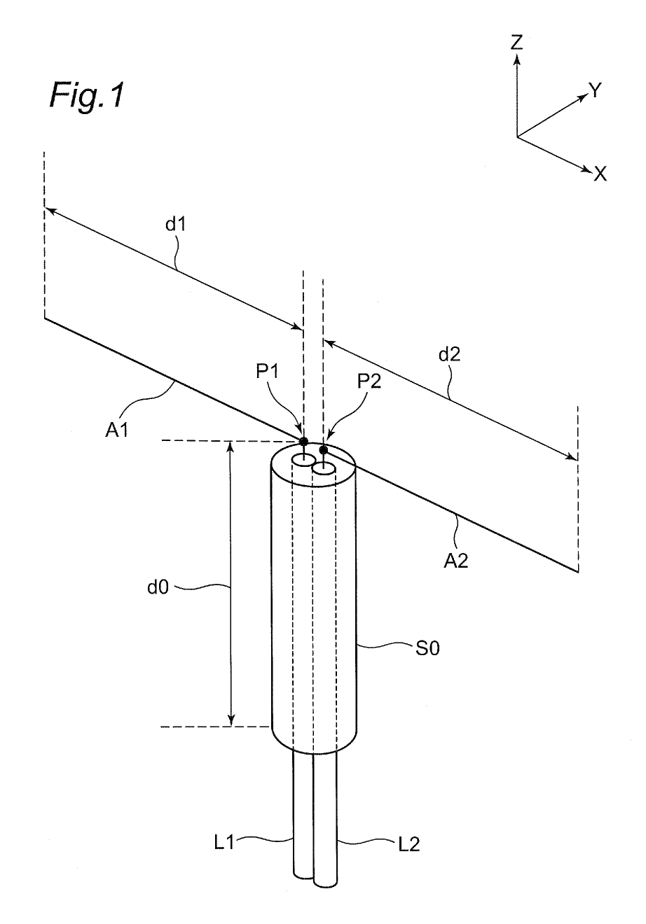

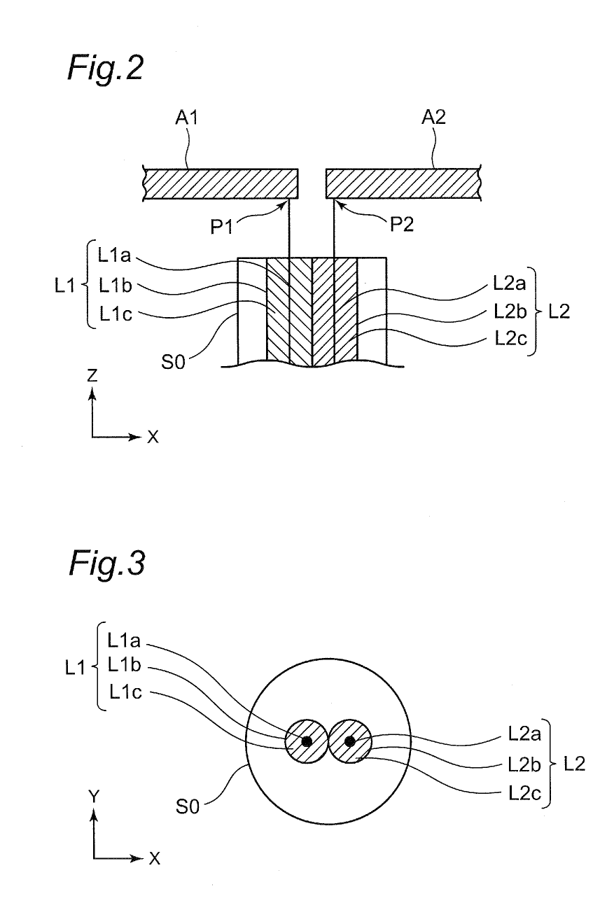

FIG. 1 is a perspective view showing a schematic configuration of an antenna apparatus according to a first embodiment of the present invention. FIG. 2 is a cross-sectional view showing a portion near feeding points P1 and P2 of the antenna apparatus of FIG. 1 and is a cross-sectional view along a plane parallel to an XZ-plane passing through the feeding points P1 and P2 and feeding lines L1 and L2. FIG. 3 is a cross-sectional view of the antenna apparatus of FIG. 1 and is a cross-sectional view along a plane parallel to an XY-plane passing through a sleeve element S0.

The antenna apparatus of the present embodiment includes two antenna elements A1 and A2; two feeding lines L1 and L2, each of which has a signal line and a ground conductor; a feeding point P1 provided at one end of the antenna element A1 and electrically connected to the signal line of the feeding line L1; and a feeding point P2 provided at one end of the antenna element A2 and electrically connected to the signal line of the feeding line L2. The feeding lines L1 and L2 extend in a first direction (−Z-direction) from the feeding points P1 and P2, respectively. The antenna element A1 extends from the feeding point P1 in a second direction (−X-direction) substantially perpendicular to the first direction, and the antenna element A2 extends from the feeding point P2 in a third direction (+X direction) being a substantially opposite direction to the second direction. The antenna apparatus further includes at least one sleeve element S0 that has one end electrically connected to the ground conductors of the feeding lines L1 and L2 at a location close to the feeding points P1 and P2, and extends in the first direction from the location close to the feeding points P1 and P2.

The antenna apparatus of the present embodiment is characterized in that by disposing the antenna elements A1 and A2 and the sleeve element S0 such that the open angles therebetween are right angles and disposing the two antenna elements A1 and A2 such that the open angle therebetween is 180 degrees, the electromagnetic coupling between the antenna elements A1 and A2 (or the electromagnetic coupling between the feeding points P1 and P2) is made to be substantially zero.

The antenna elements A1 and A2 are configured to include, for example, linear conductors having electrical lengths d1=d2=λ/4 with respect to an operating wavelength λ. The antenna elements A1 and A2 are not limited to linear conductors and may be configured to include plate-like conductors (polygonal, circular, elliptical, etc.). In addition, the antenna elements A1 and A2 may be configured asymmetrically with respect to the Z-axis or the YZ-plane.

Referring to FIGS. 2 and 3, the feeding lines L1 and L2 are configured to include, for example, coaxial cables having signal lines L1a and L2a which are inner conductors, ground conductors L1b and L2b which are outer conductors, and dielectrics L1c and L2c. Although FIGS. 2 and 3 show that the ground conductors L1b and L2b of the feeding lines L1 and L2 are in contact with each other, the feeding lines L1 and L2 may be separated from each other. In addition, the feeding lines L1 and L2 are not limited to coaxial cables and may be planar feeding lines such as parallel feeding lines and microstrip lines.

In the antenna apparatus of FIG. 1, at least one sleeve element S0 is a single cylindrical conductor that surrounds the feeding lines L1 and L2. The sleeve element S0 has an electrical length d0=λ/4 with respect to the operating wavelength λ. The one end of the sleeve element S0 is electrically short-circuited to the ground conductors L1b and L2b of the feeding lines L1 and L2 at a location close to the feeding points P1 and P2, and the other end of the sleeve element S0 is electrically open. The antenna apparatus of the present embodiment suppresses the leakage current to the feeding lines L1 and L2 by the provision of the sleeve element S0. It is noted that the sleeve element S0 is not limited to a cylindrical conductor and may be an open-core square pole or polygonal pole or may be a linear conductor as will be described later.

The antenna apparatus of the present embodiment can perform simultaneous transmission and reception of a plurality of radio signals having a low correlation therebetween by means of the antenna elements A1 and A2 by reducing the electromagnetic coupling between the antenna elements A 1 and A2, with a simpler configuration compared to those of the prior art.

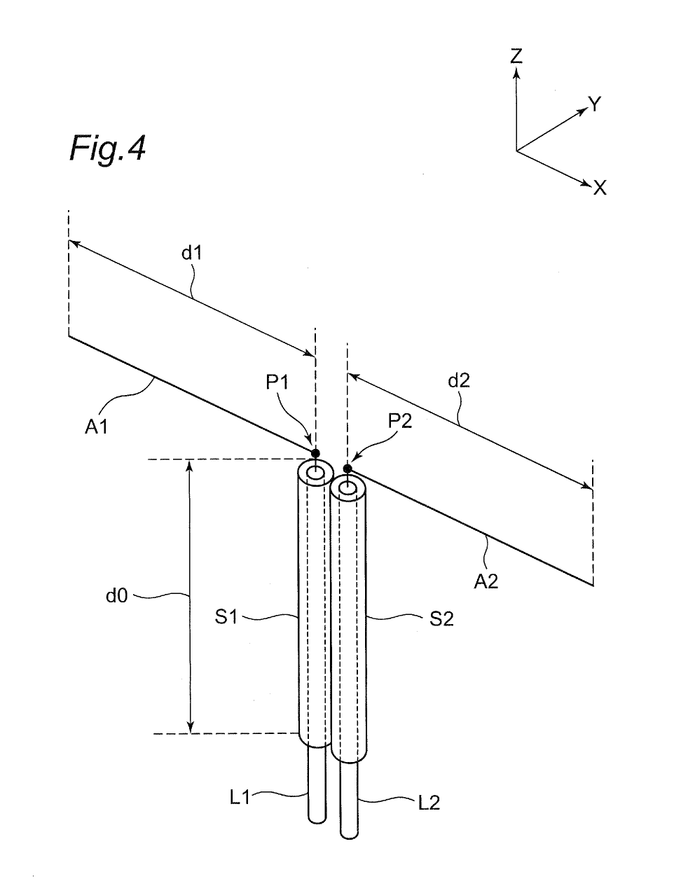

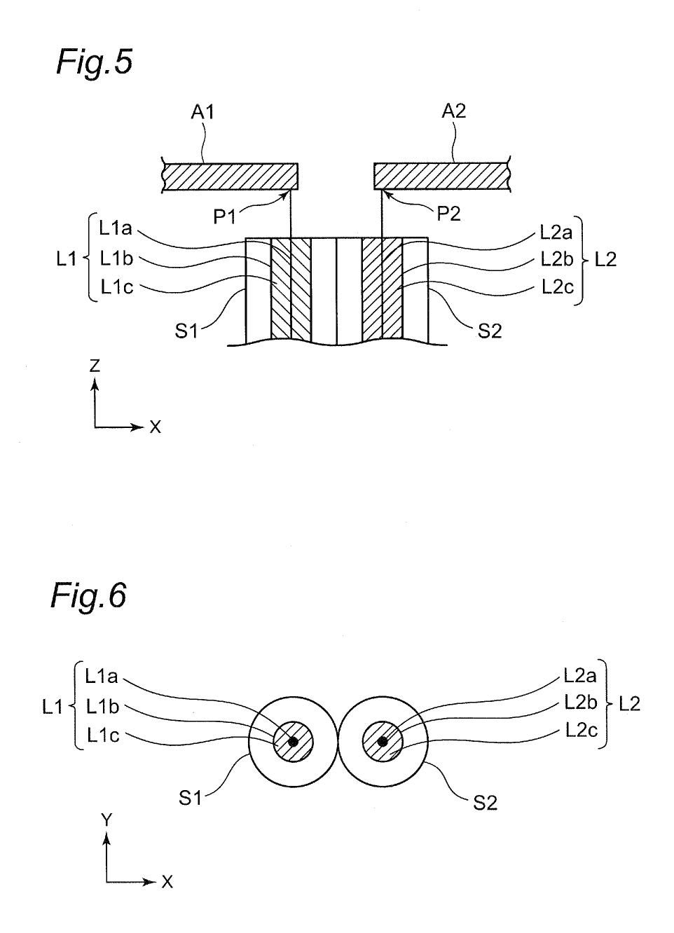

FIG. 4 is a perspective view showing a schematic configuration of an antenna apparatus according to a first modified embodiment of the first embodiment of the present invention. FIG. 5 is a cross-sectional view showing a portion near feeding points P1 and P2 of the antenna apparatus of FIG. 4 and is a cross-sectional view along a plane parallel to an XZ-plane passing through the feeding points P1 and P2 and feeding lines L1 and L2. FIG. 6 is a cross-sectional view of the antenna apparatus of FIG. 4 and is a cross-sectional view along a plane parallel to an XY-plane passing through sleeve elements S1 and S2. The antenna apparatus of the present modified embodiment is characterized by including the sleeve element S1 which is a cylindrical conductor surrounding the feeding line L1 and the sleeve element S2 which is a cylindrical conductor surrounding the feeding line L2, instead of a single sleeve element S0 surrounding the feeding lines L1 and L2. The outer regions of the two sleeve elements S1 and S2 are in a state of being in contact with each other along their longitudinal direction (a Z-axis direction) and are electrically connected to each other. While the antenna apparatus of FIGS. 1 to 3 can achieve miniaturization by the provision of a single-piece sleeve element S0, the antenna apparatus of the present modified embodiment can improve flexibility in configuration by the provision of different sleeve elements S1 and S2 for different feeding lines L1 and L2.

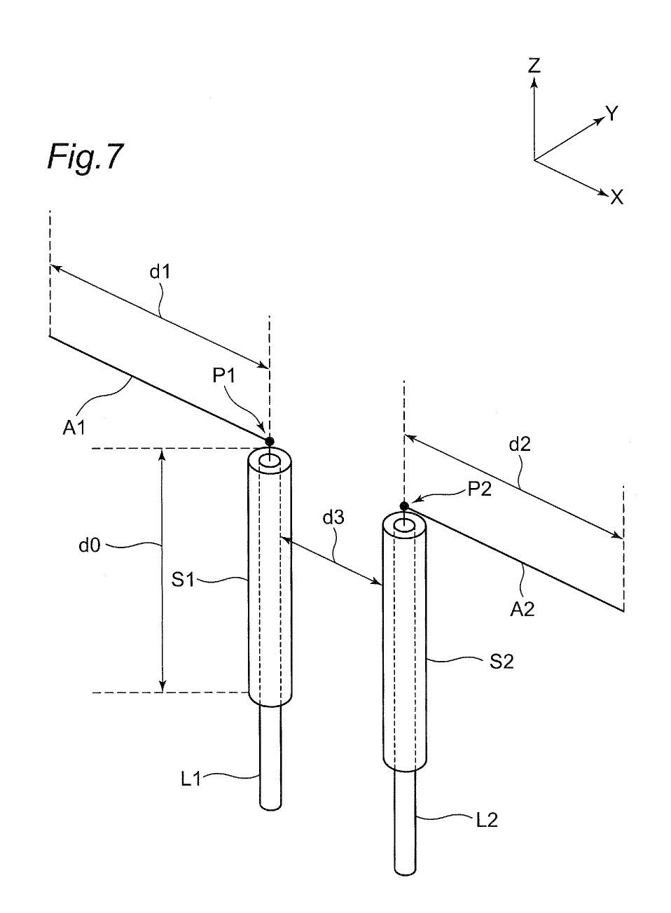

FIG. 7 is a perspective view showing a schematic configuration of an antenna apparatus according to a second modified embodiment of the first embodiment of the present invention. Although in the antenna apparatus of FIGS. 4 to 6, the outer regions of the two sleeve elements S1 and S2 are in contact with each other, as shown in FIG. 7, the two sleeve elements S1 and S2 may be separated from each other by a predetermined distance d3 at a portion where they are the closest to each other.

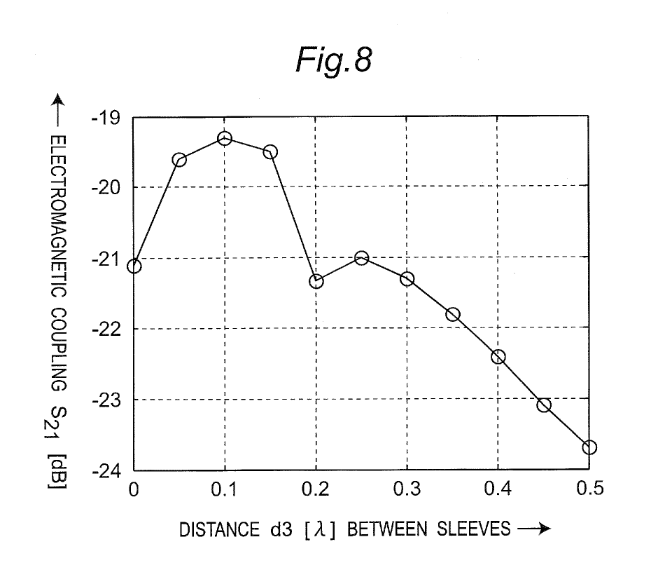

FIG. 8 is a graph showing an electromagnetic coupling between antenna elements A 1 and A2 of the antenna apparatus of FIG. 7. The horizontal axis of the graph represents the distance d3 between the sleeve elements S1 and S2 normalized by an operating wavelength and the vertical axis represents the electromagnetic coupling between the antenna elements A2 and A2 represented by a parameter S₂₁ of the transmission coefficient between feeding points P1 and P2. The electrical lengths of the sleeve elements S1 and S2 and the antenna elements A1 and A2 are d0=d1=d2=λ/4. FIG. 8 shows results of an electromagnetic field analysis performed under this condition. As can be seen from FIG. 8, even when the distance d3 between the antenna elements A1 and A2 is set to zero, the antenna apparatus of the present modified embodiment can sufficiently reduce the electromagnetic coupling.

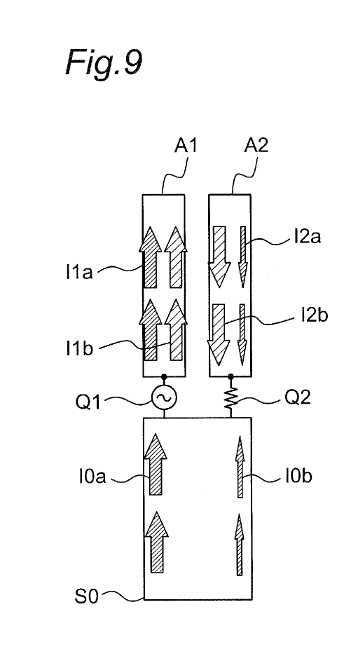

The operating principle of the antenna apparatus of the present embodiment will be described below with reference to FIGS. 9 to 14.

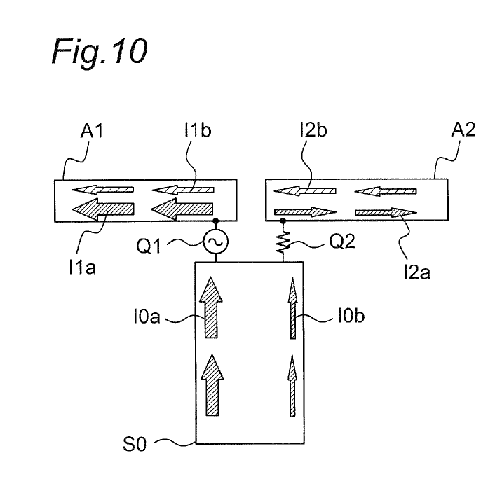

FIG. 9 is a diagram showing a current distribution of a comparative example of the antenna apparatus of FIG. 1, and FIG. 10 is a diagram showing a current distribution of the antenna apparatus of FIG. 1. In FIGS. 9 and 10, the feeding lines L1 and L2 are omitted and signal sources Q1 and Q2 are shown instead of the feeding points P1 and P2. However, it is noted that since the following description assumes the case of allowing only one signal source Q1 to operate, the other signal source Q2 is shown as a load. For the convenience of depiction, the conductive portions of the antenna elements A1 and A2 and the sleeve element S0 are intentionally shown in a thick manner. In addition, the currents on the antenna elements A1 and A2 and the sleeve element S0 are indicated by arrows and the intensities of the currents are indicated by the thickness of the arrows. The comparative example of FIG. 9 shows a current distribution for the case in which the antenna elements A 1 and A2 of FIG. 1 are provided parallel to each other and extend in the +Z-direction (i.e., the case in which the open angle between the antenna elements A1 and A2 is zero degrees). In this case, when the signal source Q1 is allowed to operate, a current I1a on the side away from the antenna element A2 and a current I1b on the side close to the antenna element A2 flow through the antenna element A1, and according to the currents I1a and I1b, a current I2a on the side away from the antenna element A1 and a current I2b on the side close to the antenna element A 1 flow through the antenna element A2. The currents I0a and I0b flow also through the sleeve element S0. The currents I1a and I1b and the currents I2a and I2b have opposite phases. At this time, since, as shown in FIG. 9, the currents I2a and I2b flow through the signal source Q2, the electromagnetic coupling between the antenna elements A 1 and A2 increases and thus radiation efficiency decreases. On the other hand, when, as shown in FIG. 10, the open angle between the antenna elements A1 and A2 is 180 degrees, due to an increase in the distance between the antenna elements A1 and A2, the currents I1b and I2b decrease, and as a result, the electromagnetic coupling between the antenna elements A 1 and A2 decreases. Due to a decrease in the distance between the sleeve element S0 and the antenna element A1, the currents I0a and I1a couple to each other and thus become stronger. As a further effect, due to a decrease in the distance between the sleeve element S0 and the antenna element A2, the direction in which the current I2a flows is reversed. As a result, as shown in FIG. 10, since the currents I2a and I2b become currents of opposite phases and thus cancel each other out, the current flowing through the signal source Q2 becomes substantially zero and accordingly the electromagnetic coupling between the antenna elements A1 and A2 also becomes substantially zero.

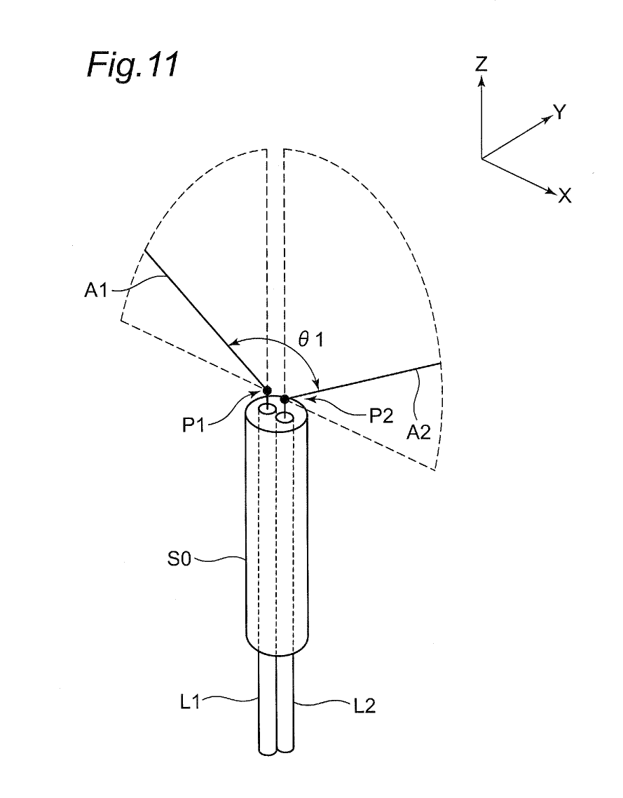

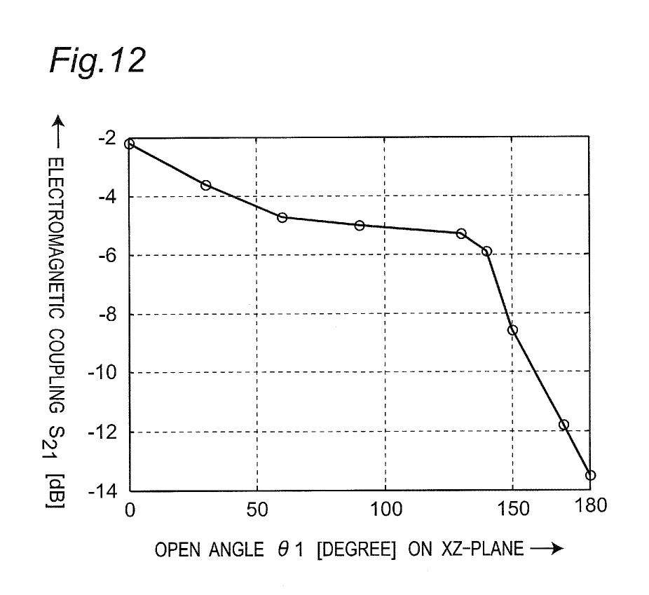

FIG. 11 is a perspective view showing a case in which the open angle between the antenna elements A1 and A2 of the antenna apparatus of FIG. 1 changes on the XZ-plane, and FIG. 12 is a graph showing an electromagnetic coupling between the antenna elements A1 and A2 of the antenna apparatus of FIG. 11. The horizontal axis of the graph represents an open angle θ1 on the XZ-plane that changes from zero degrees to 180 degrees, and the vertical axis represents the electromagnetic coupling between the antenna elements A2 and A2 represented by a parameter S₂₁ of the transmission coefficient between the feeding points P1 and P2. The electrical lengths of the sleeve element S0 and the antenna elements A1 and A2 are d0=d1=d2=λ/4. FIG. 12 shows results of an electromagnetic field analysis performed under this condition. The electromagnetic coupling between the antenna elements A1 and A2 needs to be preferably −10 dB or less. According to FIG. 12, it can be seen that when the open angle θ1 on the XZ-plane is 160 degrees or more, the electromagnetic coupling between the antenna elements A1 and A2 is −10 dB or less, and when the open angle θ1 on the XZ-plane is 180 degrees, the electromagnetic coupling between the antenna elements A1 and A2 is the lowest.

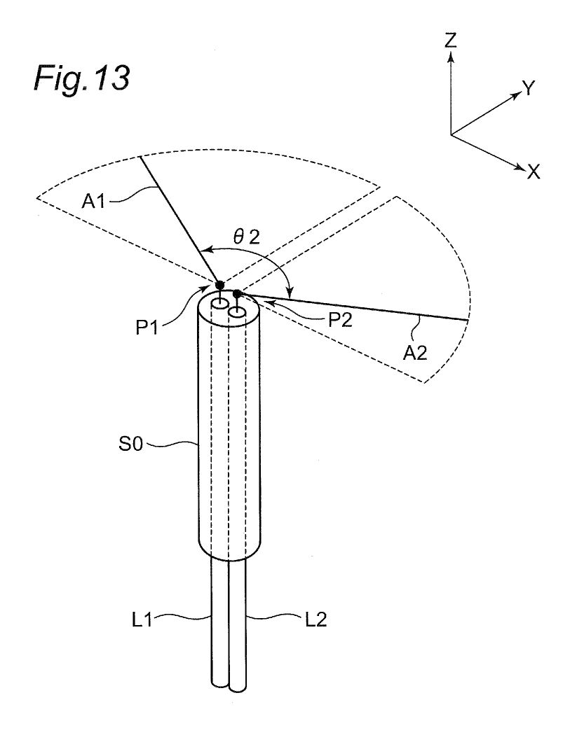

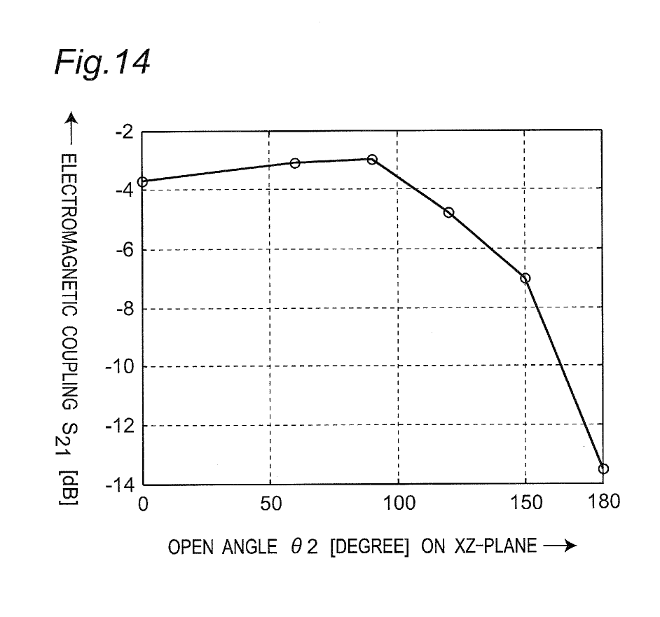

FIG. 13 is a perspective view showing a case in which the open angle between the antenna elements A 1 and A2 of the antenna apparatus of FIG. 1 changes on the XY-plane. The angles of the antenna elements A1 and A2 with respect to the sleeve element S0 are 90 degrees. FIG. 14 is a graph showing an electromagnetic coupling between the antenna elements A 1 and A2 of the antenna apparatus of FIG. 13. The horizontal axis of the graph represents an open angle θ2 on the XY-plane that changes from zero degrees to 180 degrees, and the vertical axis represents the electromagnetic coupling between the antenna elements A1 and A2 represented by a parameter S₂₁ of the transmission coefficient between the feeding points P1 and P2. The electrical lengths of the sleeve element S0 and the antenna elements A1 and A2 are d0=d1=d2=λ/4. FIG. 12 shows results of an electromagnetic field analysis performed under this condition. According to FIG. 12, it can be seen that when the open angle θ2 on the XY-plane is 180 degrees, the electromagnetic coupling between the antenna elements A 1 and A2 is the lowest.

According to the above-described results, to reduce the electromagnetic coupling between the antenna elements A1 and A2 to −10 dB or less, θ1 needs to be preferably 180 degrees and θ2 needs to be preferably 180 degrees.

It is noted that according to the antenna apparatus of the present embodiment, not only the electromagnetic coupling between the antenna elements A1 and A2 but also the correlation coefficient ρ defined below (See Non-Patent Document 2) can be reduced.

$$ρ = \frac{{\vert {s}_{11}^{*} {s}_{12} + {s}_{21}^{*} {s}_{22} \vert}^{2}}{( 1 - {\vert {s}_{11} \vert}^{2} - {\vert {s}_{21} \vert}^{2} ) ( 1 - {\vert {s}_{22} \vert}^{2} - {\vert {s}_{12} \vert}^{2} )} \qquad ( 1 )$$

According to the above equation, by reducing the transmission coefficients S₂₁ and S₁₂ and reducing the reflection coefficients S₁₁ and S₂₂, the numerator of the above equation can be brought close to substantially zero and the denominator can be brought close to substantially 1. Therefore, the correlation coefficient ρ can be reduced. It is preferred that the correlation coefficient ρ be 0.6 or less, and according to the antenna apparatus of the embodiment of the present invention, as will be described later, this value is achievable. As a result, the antenna apparatus of the present embodiment can efficiently perform simultaneous transmission and reception of the plurality of radio signals having a low correlation therebetween.

### Second Embodiment

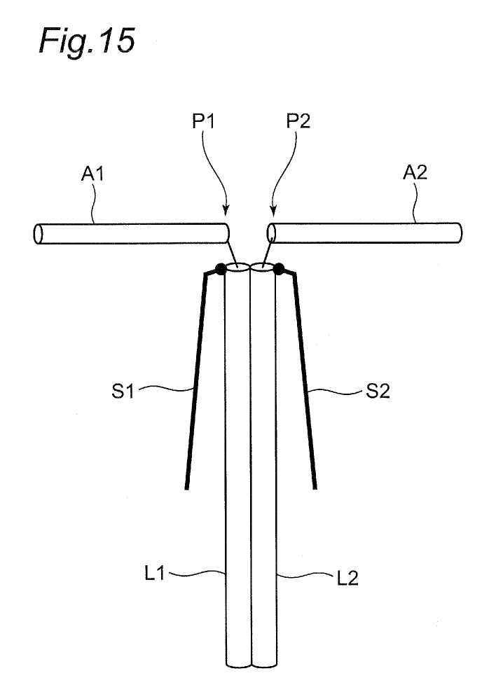

FIG. 15 is a perspective view showing a schematic configuration of an antenna apparatus according to a second embodiment of the present invention. A sleeve element is not limited to a cylindrical conductor shown in FIG. 1, etc., and may be at least one linear conductor. The antenna apparatus of the present embodiment can also perform simultaneous transmission and reception of a plurality of radio signals having a low correlation therebetween by means of antenna elements A1 and A2 by reducing the electromagnetic coupling between the antenna elements A1 and A2, with a simpler configuration compared to those of the prior art. As shown in FIG. 15, by using sleeve elements S1 and S2 of linear conductors, exceptional effects can be obtained that in particular the antenna apparatus can be reduced in weight over a sleeve element S0 of FIG. 1 by reducing the volume and weight of the sleeve element S0, and the antenna apparatus can be configured at a low cost.

FIG. 15 shows that ground conductors of feeding lines L1 and L2 are in contact with each other, but in this case, a single sleeve element may be provided instead of two sleeve elements S1 and S2. In addition, three or more sleeve elements may be provided. Increasing the number of sleeve elements can more favorably suppress the leakage current to the feeding lines L1 and L2 and also contributes to achieving a wide band.

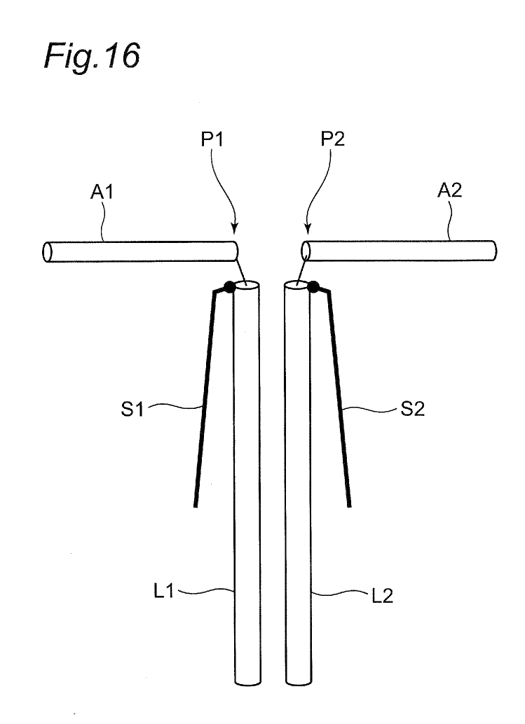

FIG. 16 is a perspective view showing a schematic configuration of an antenna apparatus according to a modified embodiment of the second embodiment of the present invention. Although FIG. 15 shows that the ground conductors of the feeding lines L1 and L2 are in contact with each other, the feeding lines L1 and L2 may be separated from each other. In this case, sleeve elements include at least one sleeve element electrically connected to the feeding line L1 and at least one sleeve element electrically connected to the feeding line L2.

### Third Embodiment

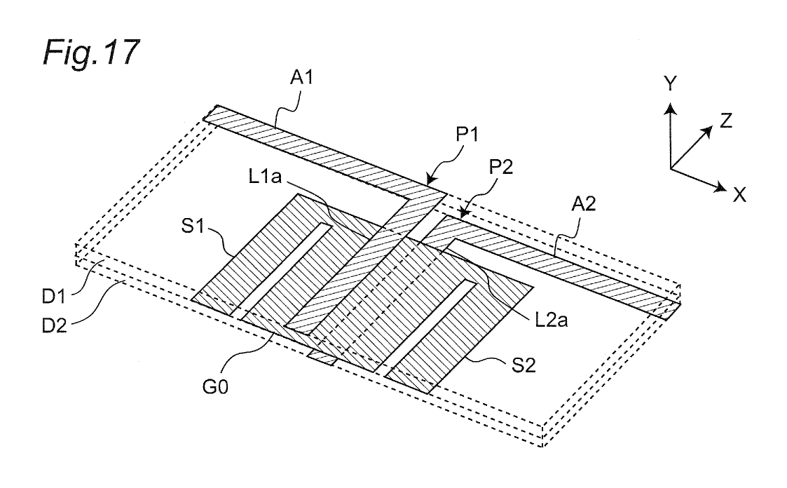

FIG. 17 is a perspective view showing a schematic configuration of an antenna apparatus according to a third embodiment of the present invention. The antenna apparatus of the present embodiment is characterized in that antenna elements A 1 and A2, sleeve elements S1 and S2, and feeding lines are configured to include conductive patterns on dielectric substrates.

The antenna apparatus of the present embodiment includes a ground conductor G0 formed between dielectric substrates D1 and D2 stacked on top of each other; a signal line L1a formed on a topside (a side on the +Z-side) of the dielectric substrate D1; and a signal line L2a formed on an underside (a side on the −Z-side) of the dielectric substrate D2. The ground conductor G0 and the signal line Lla are configured to include a first feeding line which is a microstrip line, and the ground conductor G0 and the signal line L2a are configured to include a second feeding line which is a microstrip line. The antenna apparatus further includes an antenna element A1 formed on the topside of the dielectric substrate D1 and electrically connected to the signal line L1a at a feeding point P1; and an antenna element A2 formed on the underside of the dielectric substrate D2 and electrically connected to the signal line L2a at a feeding point P2. The antenna apparatus further includes sleeve elements S1 and S2 formed between the dielectric substrates D1 and D2 and electrically connected to the ground conductor G0.

The antenna apparatus of the present embodiment can also perform simultaneous transmission and reception of a plurality of radio signals having a low correlation therebetween by means of the antenna elements A1 and A2 by reducing the electromagnetic coupling between the antenna elements A1 and A2, with a simpler configuration compared to those of the prior art. The antenna apparatus of the present embodiment can further obtain an exceptional effect of a reduction in the profile of the antenna apparatus by a planar and integral configuration achieved by the conductive patterns on the dielectric substrates.

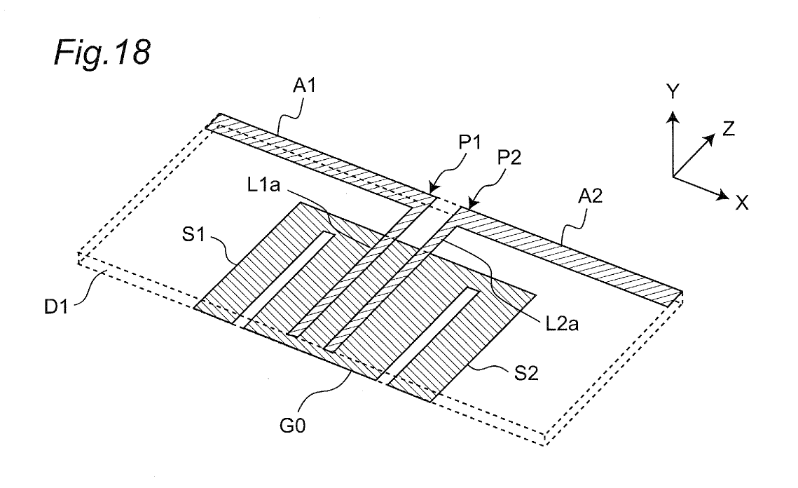

FIG. 18 is a perspective view showing a schematic configuration of an antenna apparatus according to a first modified embodiment of the third embodiment of the present invention. The antenna apparatus of the present modified embodiment is characterized by forming a signal line L2a on a topside of a dielectric substrate D1 instead of on an underside of a dielectric substrate D2 in the manner shown in FIG. 17. By this, the antenna apparatus of the present modified embodiment can be configured using a single dielectric substrate D1 by removing the dielectric substrate D2 of FIG. 17, and this leads to simplifying the configuration of the antenna apparatus.

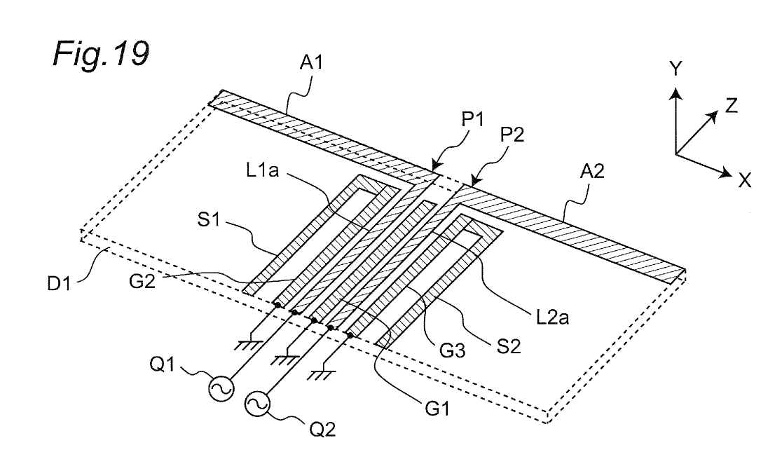

FIG. 19 is a perspective view showing a schematic configuration of an antenna apparatus according to a second modified embodiment of the third embodiment of the present invention. The antenna apparatus of the present modified embodiment is characterized by including feeding lines configured as coplanar lines. The antenna apparatus of the present modified embodiment includes signal lines L1a and L2a and ground conductors G1, G2, and G3 which are formed on a topside (a side on the +Z-side) of a dielectric substrate D1, the signal lines L1a and L2a are connected to signal sources Q1 and Q2, and the ground conductors G1, G2, and G3 are grounded. The signal line L1a and the ground conductors G1 and G2 are configured to include a first feeding line which is a coplanar line, and the signal line L2a and the ground conductors G1 and G3 are configured to include a second feeding line which is a coplanar line. The antenna apparatus further includes an antenna element A1 formed on the topside of the dielectric substrate D1 and electrically connected to the signal line L1a at a feeding point P1; and an antenna element A2 formed on the topside of the dielectric substrate D1 and electrically connected to the signal line L2a at a feeding point P2. The antenna apparatus further includes sleeve elements S1 and S2 formed on the topside of the dielectric substrate D1 and electrically connected to the ground conductors G2 and G3, respectively.

The antenna apparatus of the present embodiment is not limited to one including feeding lines which are microstrip lines or coplanar lines, and may include feeding lines of other types formed on a dielectric substrate.

Since the antenna apparatuses of FIGS. 18 and 19 can reduce the number of dielectric substrates compared to the antenna apparatus of FIG. 17, the configurations of the antenna apparatuses can be simplified. On the other hand, the antenna apparatus of FIG. 17 has the effect of being able to reduce the electromagnetic coupling between the feeding lines by providing the signal lines L1a and L2a on different sides with respect to the ground conductor G0.

### Fourth Embodiment

An antenna apparatus of the present embodiment is characterized by having a configuration for resonating the antenna apparatus at two different frequencies.

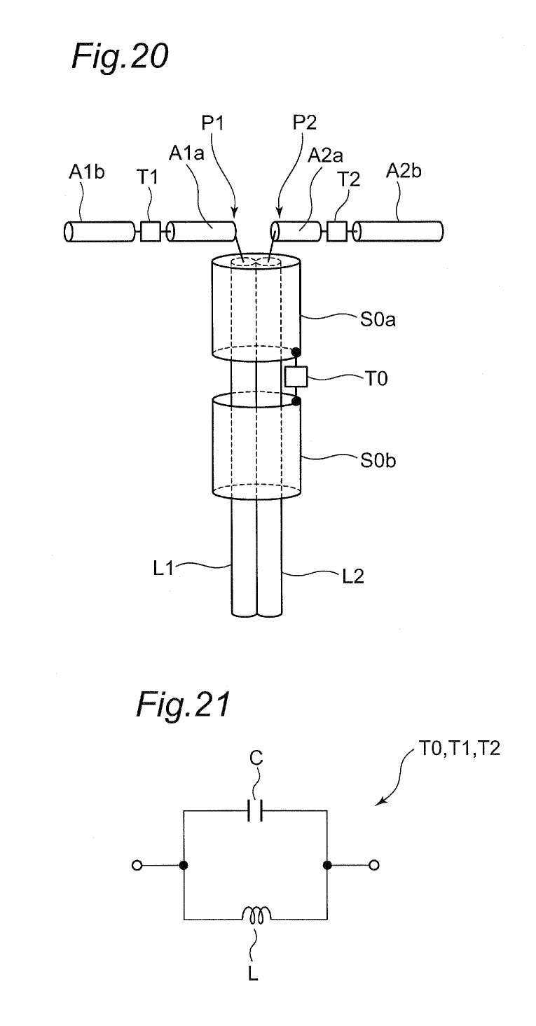

FIG. 20 is a perspective view showing a schematic configuration of an antenna apparatus according to a fourth embodiment of the present invention. The antenna apparatus of FIG. 20 corresponds to one including trap circuits at locations in the middle in the longitudinal directions of antenna elements A1 and A2 and a sleeve element S0 of an antenna apparatus of FIG. 1, by which the antenna apparatus resonates at different first and second frequencies. The antenna apparatus of FIG. 20 includes split sleeve elements S0a and S0b (collectively, referred to as a sleeve element S0); a trap circuit T0 provided between the sleeve elements S0a and S0b; split antenna elements A1a and A1b (collectively, referred to as an antenna element A1); a trap circuit T1 provided between the antenna elements A1a and A1b; split antenna elements Ata and A1b (collectively, referred to as an antenna element A2); and a trap circuit T2 provided between the antenna elements A2a and A1b. The antenna elements A1 and A2 and the sleeve element S0 have a first electrical length, the antenna element A 1 includes the trap circuit T1 at a location of a second electrical length different than the first electrical length from a feeding point P1, the antenna element A2 includes the trap circuit T2 at a location of the second electrical length from a feeding point P2, and the sleeve element S0 includes the trap circuit T0 at a location of the second electrical length from one end thereof connected to ground conductors of feeding lines L1 and L2. The configurations of other portions of the antenna apparatus of FIG. 20 are the same as those of the antenna apparatus of FIG. 1.

FIG. 21 is a circuit diagram showing trap circuits T0, T1, and T2 of FIG. 20. The trap circuits T0, T1, and T2 are parallel resonant circuits including a capacitor C and an inductor L, and are made to be substantially a short-circuit at a predetermined frequency f1 and are substantially open at a predetermined frequency f2 higher than the frequency f1. When the antenna apparatus of FIG. 20 operates at the frequency f1, the entire antenna elements A 1 and A2 and sleeve element S0 resonate. On the other hand, when the antenna apparatus operates at the frequency f2, only the antenna elements A1a and A2a and the sleeve element S0a resonate. As such, each of the antenna elements A1 and A2 and the sleeve element S0 has two electrical lengths at which the antenna apparatus resonates while being a single element, and thus, the antenna apparatus resonates at two different frequencies.

The antenna apparatus of the present embodiment can also perform simultaneous transmission and reception of a plurality of radio signals having a low correlation therebetween by means of the antenna elements A1 and A2 by reducing the electromagnetic coupling between the antenna elements A 1 and A2, with a simpler configuration compared to those of the prior art. The antenna apparatus of the present embodiment can further achieve multi-band operation where the antenna apparatus resonates at two different frequencies.

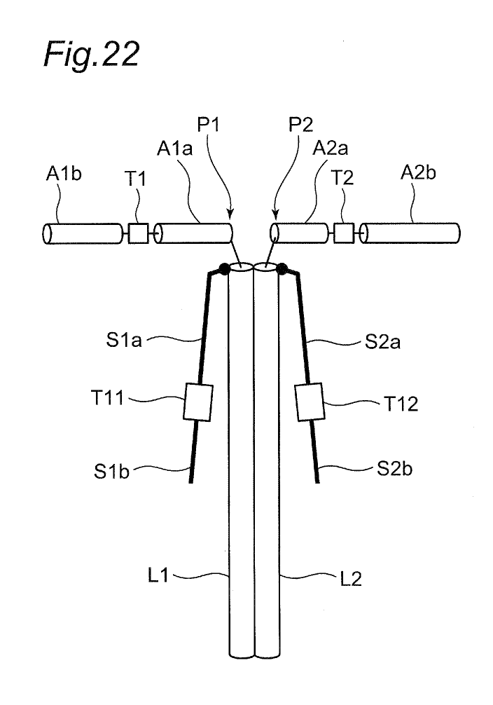

FIG. 22 is a perspective view showing a schematic configuration of an antenna apparatus according to a first modified embodiment of the fourth embodiment of the present invention. The configuration including trap circuits of the present embodiment is applicable not only to an antenna apparatus including a sleeve element which is a cylindrical conductor such as that shown in FIG. 1, and but also to an antenna apparatus including sleeve elements which are linear conductors such as those shown in FIG. 15. The antenna apparatus of FIG. 22 corresponds to one including trap circuits at locations in the middle in the longitudinal directions of antenna elements A1 and A2 and sleeve elements S1 and S2 of an antenna apparatus of FIG. 15, by which the antenna apparatus resonates at different first and second frequencies. The antenna apparatus of FIG. 22 includes split sleeve elements S1a and S1b (collectively, referred to as a sleeve element S1); a trap circuit T11 provided between the sleeve elements S1a and S1b; split sleeve elements S2a and S2b (collectively, referred to as a sleeve element S2); and a trap circuit T12 provided between the sleeve elements S2a and S2b. The configurations of other portions of the antenna apparatus of FIG. 22 are the same as those of the antenna apparatus of FIG. 20.

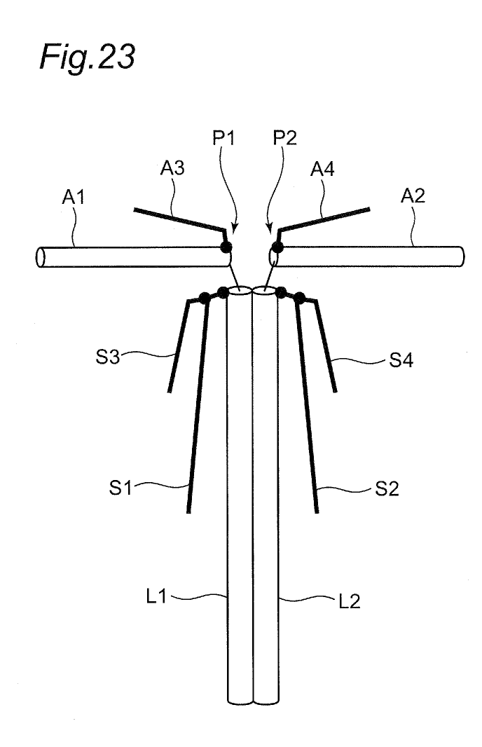

FIG. 23 is a perspective view showing a schematic configuration of an antenna apparatus according to a second modified embodiment of the fourth embodiment of the present invention. In the antenna apparatus of the present embodiment, the configuration for achieving multi-band operation is not limited to trap circuits and the antenna apparatus may include antenna elements and sleeve elements having different electrical lengths. The antenna apparatus of FIG. 23 corresponds to one in which an antenna apparatus of FIG. 15 further includes additional antenna elements A3 and A4 and sleeve elements S3 and S4. In the antenna apparatus of FIG. 23, antenna elements A1 and A2 and sleeve elements S1 and S2 have a predetermined first electrical length, and the antenna elements A3 and A4 and the sleeve elements S3 and S4 have a predetermined second electrical length different than the first electrical length. The antenna element A3 extends from a feeding point P1 in a fourth direction substantially perpendicular to a first direction in which feeding lines L1 and L2 and the sleeve elements S1 to S4 extend, and the antenna element A4 extends from a feeding point P2 in a fifth direction which is a substantially opposite direction to the fourth direction. Although in FIG. 23, the antenna element A3 extends in substantially the same direction as the antenna element A1 and the antenna element A4 extends in substantially the same direction as the antenna element A2, the directions are not limited thereto. By configuring the electrical length of the antenna elements A1 and A2 and the sleeve elements S1 and S2 such that the antenna apparatus resonates at a predetermined frequency f1, and configuring the electrical length of the antenna elements A3 and A4 and the sleeve elements S3 and S4 such that the antenna apparatus resonates at a predetermined frequency f2 higher than the frequency f1, the antenna apparatus of FIG. 23 can achieve multi-band operation where the antenna apparatus resonates at two different frequencies. In this case, the antenna apparatus only needs to be designed such that each electrical length is on the order of λ/4 with respect to an operating wavelength λ of a desired frequency, and thus has such a feature that the fabrication thereof is easy.

It is noted that the antenna apparatus of FIG. 20 has such a feature that a leakage current to the feeding lines L1 and L2 is reduced over the antenna apparatus of FIG. 22.

The configurations of the fourth embodiment described with reference to FIGS. 20 to 23 may be combined. For example, antenna elements A1 and A2 including trap circuits T1 and T2 of FIG. 22 and the sleeve elements S1 to S4 of FIG. 23 may be combined, or the sleeve element S0 including the trap circuit T0 of FIG. 20 (or the sleeve elements S1 and S2 including the trap circuits T11 and T12 of FIG. 22) and the antenna elements A1 to A4 of FIG. 23 may be combined. In addition, any of the configurations of the fourth embodiment and any of the configurations of other embodiments shown in FIGS. 4, 7, 17 to 19, etc., may be combined.

### Implementation Example 1

Simulation results for the antenna apparatus according to the embodiments of the present invention will be described below.

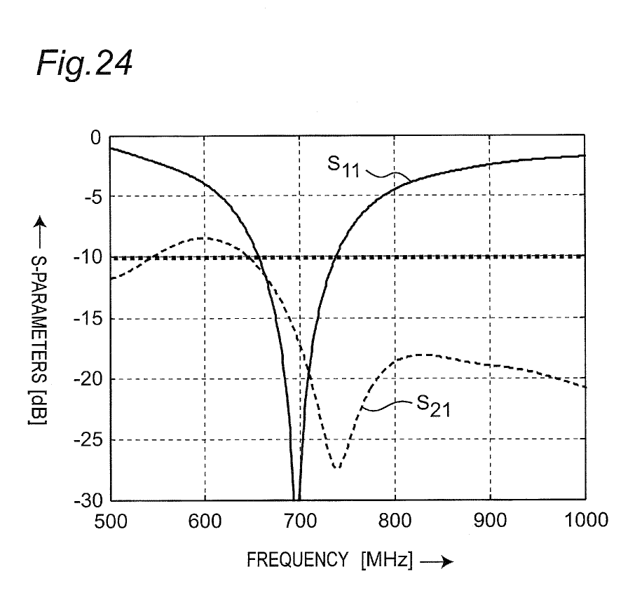

FIG. 24 is a graph showing S-parameters of an antenna apparatus according to an implementation example of the present invention. In the antenna apparatus of FIG. 1, the electrical lengths of the antenna elements A1 and A2 and the sleeve element S0 are set to d0=d1=d2=100 mm. The graph of FIG. 24 shows results obtained by performing a transient analysis using an FDTD method in a frequency range of 500 to 1000 MHz. In this case, taking into account the shortening rate, the antenna apparatus is supposed to resonate near about 700 MHz. It can be seen that both a parameter S₁₁ of the reflection coefficient and a parameter S₂₁ of the transmission coefficient are −10 dB or less near a resonance frequency of 700 MHz and thus the electromagnetic coupling between the antenna elements A1 and A2 is sufficiently low.

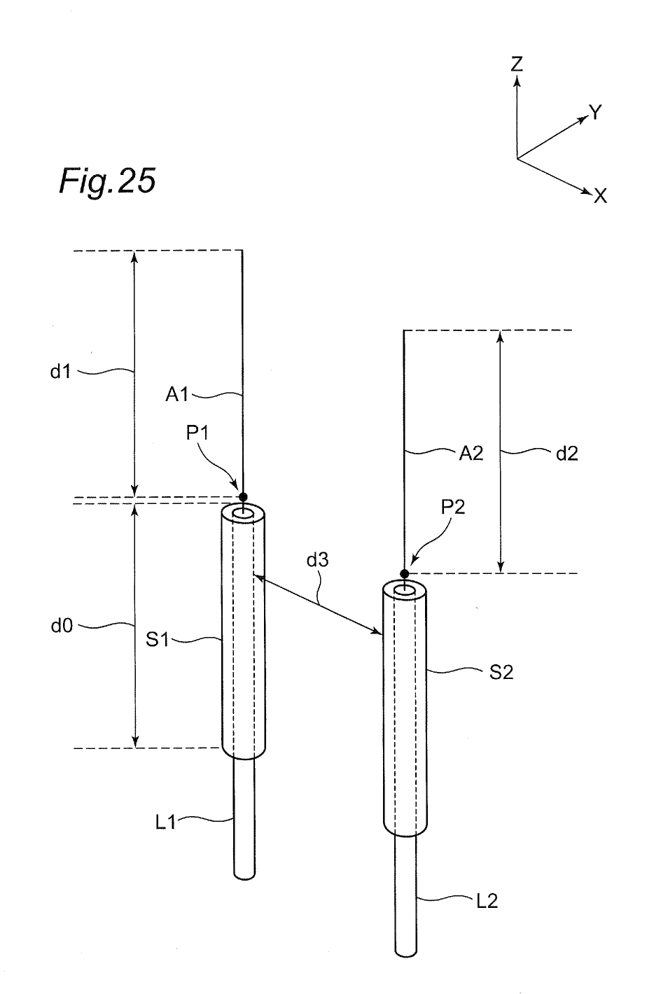

FIG. 25 is a perspective view showing a schematic configuration of an antenna apparatus according to a comparative example. In the antenna apparatus of the comparative example, antenna elements A1 and A2 are provided parallel to each other and extend in a +Z-direction (i.e., the open angle between the antenna elements A1 and A2 is zero degrees).

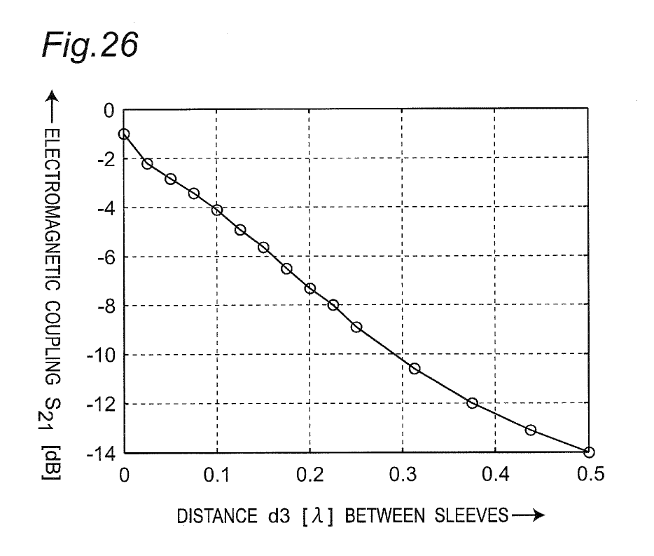

FIG. 26 is a graph showing an electromagnetic coupling between the antenna elements A1 and A2 of the antenna apparatus of FIG. 25. The horizontal axis of the graph represents a distance d3 between sleeve elements S1 and S2 normalized by an operating wavelength λ and the vertical axis represents the electromagnetic coupling between the antenna elements A2 and A2 represented by a parameter S₂₁ of the transmission coefficient between feeding points P1 and P2. The electrical lengths of the sleeve elements S1 and S2 and the antenna elements A1 and A2 are d0=d1=d2=100 mm. It can be seen that in the antenna apparatus of the comparative example, when the distance d3 between the sleeve elements S1 and S2 is small, the electromagnetic coupling between the antenna elements A1 and A2 is large.

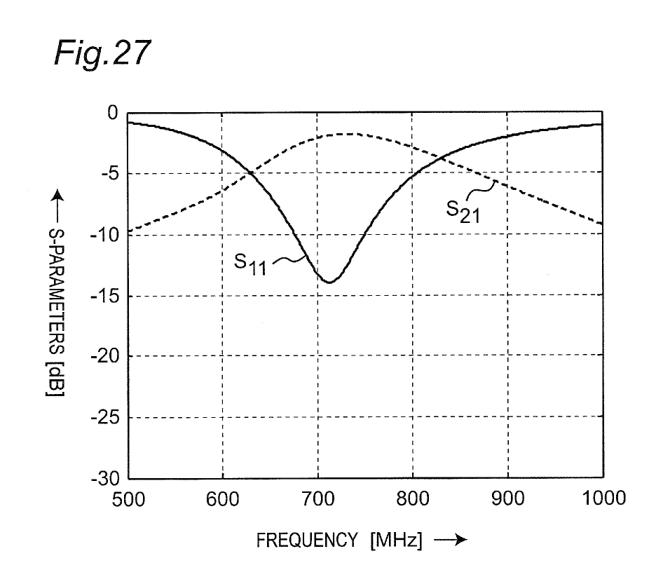

FIG. 27 is a graph showing S-parameters of the antenna apparatus of FIG. 25. In the following, in FIGS. 27 to 29, it is assumed that in the antenna apparatus of the comparative example, the distance d3 in FIG. 25 is 10 mm. The conditions and the method for simulations are the same as those in FIG. 24. In this case, taking into account the shortening rate, the antenna apparatus of the comparative example is supposed to resonate near about 700 MHz. At a resonance frequency of 710 MHz, a parameter S₁₁ of the reflection coefficient is −10 dB or less, but a parameter S₂₁ of the transmission coefficient exhibits a value as high as −5 dB or more.

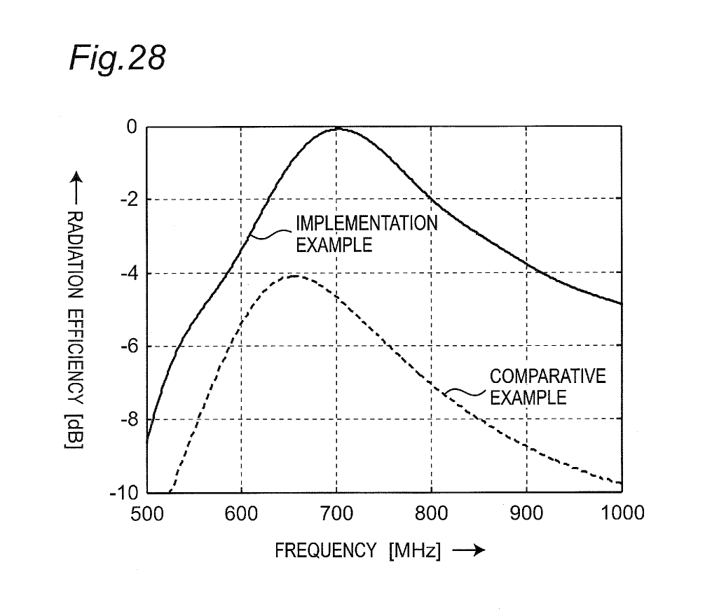

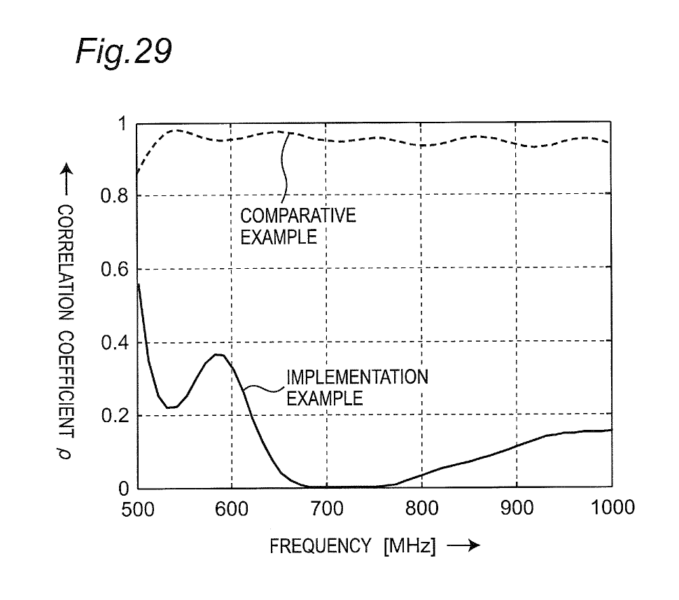

In the following, with reference to FIGS. 28 and 29, the radiation efficiency and correlation coefficient are compared between the antenna apparatus of the implementation example and the antenna apparatus of the comparative example.

FIG. 28 is a graph showing radiation efficiencies of the antenna apparatuses according to the implementation example of the present invention and the comparative example. This graph shows frequency characteristics of the radiation efficiencies. In this case, the radiation efficiencies are derived by “1-S₁₁²-S₂₁²”. The graph of FIG. 28 shows results obtained by performing a transient analysis using an FDTD method in a frequency range of 500 to 1000 MHz. It can be seen that in the antenna apparatus of the comparative example, since electromagnetic coupling S₂₁ is large, the radiation efficiency exhibits a value as low as −4 dB or less over frequencies of 500 to 1000 MHz, but in the antenna apparatus of the implementation example, the radiation efficiency exhibits a value as high as −4 dB or more over a frequency bandwidth of 330 MHz.

FIG. 29 is a graph showing correlation coefficients of the antenna apparatuses according to the implementation example of the present invention and the comparative example. The graph of FIG. 29 shows results obtained by determining S-parameters using an FDTD method in a frequency range of 500 to 1000 MHz and computing correlation coefficients ρ using equation 1. According to the graph of FIG. 29, it can be seen that in the antenna apparatus of the comparative example, since electromagnetic coupling is high, the correlation coefficient exhibits a value as high as 0.8 or more, but in the antenna apparatus of the implementation example, the correlation coefficient exhibits a value as low as 0.6 or less.

It can be seen from the above results that the antenna apparatus according to the embodiment of the present invention can reduce the electromagnetic coupling between the feeding points and thus can perform simultaneous transmission and reception of the plurality of radio signals having a low correlation therebetween.

It is noted that although in the present implementation example, the antenna apparatus is designed to operate near 700 MHz, by changing the electrical lengths of the antenna elements and the sleeve element, the antenna apparatus is also applicable at other frequencies than the above-described frequency.

### INDUSTRIAL APPLICABILITY

The antenna apparatuses of the present invention and wireless communication apparatuses using the antenna apparatuses can be implemented as, for example, mobile phones or can also be implemented as apparatuses for wireless LANs. The antenna apparatuses can be mounted on, for example, wireless communication apparatuses for performing communication of a MIMO system. In addition to the MIMO system, the antenna apparatuses can also be mounted on (multi-applications) array antenna apparatuses capable of simultaneously performing communications for a plurality of applications, such as adaptive array antennas, maximal-ratio combining diversity antennas, and phased-array antennas.

### DESCRIPTION OF REFERENCE CHARACTERS

A1, A2, A3, A4, A1a, A1b, Ata, and A2b: Antenna element;
D1 and D2: Dielectric substrate;
G0, G1, G2, and G3: Ground conductor;
I0a, I0b, I1a, I1b, I2a, and I2b: Current;
L1 and L2: Feeding line;
L1a and L2a: Signal line;
L1b and L2b: Ground conductor;
L1c and L2c: Dielectric;
P1 and P2: Feeding point;
Q1 and Q2: Signal source;
S0, S1, S2, S3, S4, S0a, S0b, S1a, S1b, S2a, and S2b: Sleeve element; and
T0, T1, T2, T11, and T12: Trap circuit.

1. An antenna apparatus comprising:
first and second antenna elements;
first and second feeding lines, each having a signal line and a ground conductor;
a first feeding point provided at one end of the first antenna element and connected to the signal line of the first feeding line; and
a second feeding point provided at one end of the second antenna element and connected to the signal line of the second feeding line,
wherein the first and second feeding lines extend in a first direction from the first and second feeding points, respectively,
wherein the first antenna element extends from the first feeding point in a second direction substantially perpendicular to the first direction,
wherein the second antenna element extends from the second feeding point in a third direction being a substantially opposite direction to the second direction, and
wherein the antenna apparatus further comprises at least one sleeve element that has one end connected to the ground conductors of the first and second feeding lines at a location close to the first and second feeding points, and extends in the first direction from the location close to the first and second feeding points.

2. The antenna apparatus as claimed in claim 1,
wherein at least one of the sleeve elements is a single cylindrical conductor that surrounds the first and second feeding lines.

3. The antenna apparatus as claimed in claim 1,
wherein at least one of the sleeve elements includes a first sleeve element being a single cylindrical conductor that surrounds the first feeding line; and a second sleeve element being a single cylindrical conductor that surrounds the second feeding line.

4. The antenna apparatus as claimed in claim 3,
wherein the first and second sleeve elements are in contact with each other.

5. The antenna apparatus as claimed in claim 3,
wherein the first and second sleeve elements are separated from each other.

6. The antenna apparatus as claimed in claim 1,
wherein at least one of the sleeve elements is at least one linear conductor.

7. The antenna apparatus as claimed in claim 6,
wherein the ground conductors of the first and second feeding lines are in contact with each other.

8. The antenna apparatus as claimed in claim 6,
wherein the first and second feeding lines are separated from each other, and
wherein at least one of the sleeve elements includes at least one sleeve element connected to the first feeding line; and at least one sleeve element connected to the second feeding line.

9. The antenna apparatus as claimed in claim 1,
wherein the first and second feeding lines are microstrip lines formed on a dielectric substrate, and
wherein the first and second antenna elements and at least one of the sleeve elements are formed in patterns on the dielectric substrate.

10. The antenna apparatus as claimed in claim 1,
wherein the first and second feeding lines are coplanar lines formed on a dielectric substrate, and
wherein the first and second antenna elements and at least one of the sleeve elements are formed in patterns on the dielectric substrate.

11. The antenna apparatus as claimed in claim 1,
wherein the first and second antenna elements and at least one of the sleeve elements have a first electrical length,
wherein the first antenna element includes a first trap circuit at a location of a second electrical length different than the first electrical length, from the first feeding point,
wherein the second antenna element includes a second trap circuit at a location of the second electrical length from the second feeding point,
wherein at least one of the sleeve elements includes a third trap circuit at a location of the second electrical length from the one end thereof connected to the ground conductors of the first and second feeding lines, and
wherein each of the first, second, and third trap circuits is made to be substantially a short-circuit at a first frequency, and is substantially open at a second frequency higher than the first frequency.

12. The antenna apparatus as claimed in claim 6,
wherein the first and second antenna elements have a first electrical length,
wherein the antenna apparatus further comprises third and fourth antenna elements each having a second electrical length different than the first electrical length,
wherein the third antenna element extends from the first feeding point in a fourth direction substantially perpendicular to the first direction,
wherein the fourth antenna element extends from the second feeding point in a fifth direction being a substantially opposite direction to the fourth direction, and
wherein at least one of the sleeve elements includes a first sleeve element having the first electrical length; and a second sleeve element having the second electrical length.

13. A wireless communication apparatus comprising an antenna apparatus, the antenna apparatus comprising:
first and second antenna elements;
first and second feeding lines, each having a signal line and a ground conductor;
a first feeding point provided at one end of the first antenna element and connected to the signal line of the first feeding line; and
a second feeding point provided at one end of the second antenna element and connected to the signal line of the second feeding line,
wherein the first and second feeding lines extend in a first direction from the first and second feeding points, respectively,
wherein the first antenna element extends from the first feeding point in a second direction substantially perpendicular to the first direction,
wherein the second antenna element extends from the second feeding point in a third direction being a substantially opposite direction to the second direction, and
wherein the antenna apparatus further comprises at least one sleeve element that has one end connected to the ground conductors of the first and second feeding lines at a location close to the first and second feeding points, and extends in the first direction from the location close to the first and second feeding points.
